(19) United States
(12) Patent Application Publication
(10) Pub. No.: US 2025/0136801 A1
(43) Pub. Date: May 1, 2025

(54) FLAME-RETARDANT RUBBER COMPOSITION, FLAME-RETARDANT RUBBER CROSSLINKED BODY, AND ARTICLE

(71) Applicant: UCHIYAMA MANUFACTURING CORP., Okayama (JP)

(72) Inventors: Chihiro OHMORI, Dusseldorf (DE); Yuji YASUFUKU, Okayama (JP)

(21) Appl. No.: 18/909,074

(22) Filed: Oct. 8, 2024

(30) Foreign Application Priority Data
Nov. 1, 2023 (JP) 2023-187886

(51) Int. Cl. C08L 23/16; C08K 3/22; C08K 5/00

(52) U.S. Cl. CPC C08L 23/16; C08K 3/22; C08K 5/0066; C08K 2003/2227; C08L 2201/02

(57) ABSTRACT

Provided is a flame-retardant rubber composition, including components A to D below, component A: ethylene-propylene-diene rubber; component B: hydrated metal oxide; component C: phosphorus flame-retardant plasticizer; and component D: mineral oil, in which when a content of the component A is 100 parts by weight, a content of the component B is 80 to 200 parts by weight, a content of the component C is 1 to 15 parts by weight, and a content of the component D is 1 to 30 parts by weight.

### CROSS-REFERENCE TO RELATED APPLICATION

This application claims priority from Japanese Patent Application No. 2023-187886 filed with the Japan Patent Office on Nov. 1, 2023, the entire content of which is hereby incorporated by reference.

### BACKGROUND

### 1. Technical Field

The present disclosure relates to a flame-retardant rubber composition, a flame-retardant rubber crosslinked body, and an article.

### 2. Related Art

Ethylene-propylene-diene rubber (EPDM) is used for ample applications including automobile parts. There is a scene where EPDM is required to be flame-retardant depending on the application. Therefore, various flame-retardant EPDM-containing compositions are proposed (for example, see JP-T-2023-517048).

### SUMMARY

A flame-retardant rubber composition according to an embodiment of the present disclosure includes components A to D below, component A: ethylene-propylene-diene rubber; component B: hydrated metal oxide; component C: phosphorus flame-retardant plasticizer; and component D: mineral oil, in which when a content of the component A is 100 parts by weight, a content of the component B is 80 to 200 parts by weight, a content of the component C is 1 to 15 parts by weight, and a content of the component D is 1 to 30 parts by weight.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details.

The composition disclosed in JP-T-2023-517048 is characterized by not containing mineral oil. However, the present inventors intensively conducted research and newly found a problem that rubber obtained from a composition which does not contain mineral oil is excessively hard or is inferior in surface properties.

A problem to be solved by the present embodiment is to provide a flame-retardant rubber composition which satisfies all of flame retardancy, flexibility, and surface properties.

For solving the above-described problem, the flame-retardant rubber composition according to the present embodiment includes components A to D below. Component A: ethylene-propylene-diene rubber Component B: hydrated metal oxide Component C: phosphorus flame-retardant plasticizer Component D: mineral oil.

When the content of the component A is 100 parts by weight, contents of the components B to D are as follows.

Component B: 80 to 200 parts by weight Component C: 1 to 15 parts by weight

Component D: 1 to 30 parts by weight

According to the present embodiment, there is provided a flame-retardant rubber composition which satisfies all of flame retardancy, flexibility, and surface properties.

Hereinafter, an example of the embodiment of the present disclosure will be described in detail. However, the present embodiment is not limited to the below-described embodiments. Various modifications are possible within the technical scope of the present embodiment. An embodiment including a combination of technical measures described in different embodiments is also contained in the technical scope of the present embodiment.

In the following description of the present embodiment, “A to B” indicating a value range denotes “A or more and B or less”, unless otherwise stated.

### 1. Components Contained in Flame-Retardant Rubber Composition

The flame-retardant rubber composition according to the present embodiment includes component A: ethylene-propylene-diene rubber, component B: hydrated metal oxide, component C: phosphorus flame-retardant plasticizer, and component D: mineral oil. The flame-retardant rubber composition may include, as an optional component, component E: silane coupling agent and/or component F: filler. The flame-retardant rubber composition may include an additive other than those described above. Only one of these components may be used. Alternatively, two or more components may be combined and used. Hereinafter, each component will be described in detail.

### 1-1. Component A: Ethylene-Propylene-Diene Rubber

Component A is ethylene-propylene-diene rubber (EPDM). Ethylene-propylene-diene rubber is a rubber obtained by copolymerization of ethylene, propylene, and diene monomers.

Examples of the diene monomer constituting component A include a chain diene and a cyclic diene. Examples of the chain diene include 1,4-pentadiene, 1,4-hexadiene, 1,5-hexadiene, 1,4-heptadiene, 2-methyl-1,5-hexadiene, 1,4-octaadiene, 1,6-octadiene, 1,7-octadiene, 6-methyl-1,5-heptadiene, and 7-methyl-1,6-octadiene. Examples of the cyclic diene include cyclohexadiene, cyclooctadiene, dicyclopentadiene, alkyldicyclopentadiene, methyltetrahydroindene, 5-vinylnorbornene, 5-ethylidene-2-norbornene, 5-methylene-2-norbornene, 5-n-propylidene-2-norbornene, 5-isopropyliden-2-norbornene, 5-(2-methyl-2-butenyl)-2-norbornene, and 6-chloromethyl-5-isopropenyl-2-norbornene. Among these, 5-ethylidene-2-norbornene, which is fast in the crosslinking rate and excellent in the physical properties balance of the crosslinked body, is preferable.

The lower limit of the content of an ethylene-derived unit in component A, when the weight of component A is 100% by weight, can be 30% by weight or more or 40% by weight or more. The upper limit of the content of an ethylene-derived unit in component A, when the weight of component A is 100% by weight, can be 85% by weight or less or 80% by weight or less.

The lower limit of the content of a diene monomer-derived unit in component A, when the weight of component A is 100% by weight, can be 0.5% by weight or more or 1% by weight or more. The upper limit of the content of an ethylene-derived unit in component A, when the weight of component A is 100% by weight, can be 20% by weight or less or 15% by weight or less.

The flame-retardant rubber composition may include a rubber component other than component A. Examples of the rubber other than component A include fluorine rubber (FKM), natural rubber (NR), styrene-butadiene rubber (SBR), isoprene rubber (IR), butadiene rubber (BR), chloroprene rubber (CR), acrylonitrile-butadiene rubber (NBR), butyl rubber (IIR), ethylene-propylene rubber (EPM), urethane rubber (U), ethylene acryl rubber (AEM), acryl rubber (ACM), and silicone rubber (Q). Among these, one or more rubber components selected from the group consisting of natural rubber (NR), styrene-butadiene rubber (SBR), isoprene rubber (IR), butadiene rubber (BR), acrylonitrile-butadiene rubber (NBR), butyl rubber (IIR), ethylene⋅propylene rubber (EPM), urethane rubber (U), ethylene acryl rubber (AEM), acryl rubber (ACM), and silicone rubber (Q), which do not contain halogen, are preferable.

Among the rubber components in the flame-retardant rubber composition, the main component is preferably component A. In one embodiment, the weight ratio of component A in all rubber components contained in the flame-retardant rubber composition is 70% by weight or more, 80% by weight or more, or 90% by weight or more. In one embodiment, the flame-retardant rubber composition may not include the rubber component other than component A.

### 1-2. Component B: Hydrated Metal Oxide

Component B is hydrated metal oxide. Hydrated metal oxide is a hydrate of metal oxide. This hydrate of metal oxide is generally represented by a chemical formula of M(OH)n.

Examples of component B include aluminum hydroxide, magnesium hydroxide, magnesium/nickel composite hydroxide, and magnesium/zinc composite hydroxide. Among these, aluminum hydroxide and/or magnesium hydroxide are preferable. Aluminum hydroxide is more preferable. The endothermic amount of these components during pyrolysis is large. Therefore, the effect of improving flame retardancy is high.

The lower limit of the average particle diameter (D50) of component B may be 0.1 μm or more or 0.5 μm or more. The upper limit of the average particle diameter (D50) of component B may be 5.0 μm or less, 3.0 μm or less, or 2.0 μm or less. Examples of the aluminum hydroxide having an average particle diameter within the above-described range include BF013, BF703, BF1403, and BF103 (all manufactured by Nippon Light Metal Co., Ltd.). Examples of the magnesium hydroxide having an average particle diameter within the above-described range include KISUMA (R) 5A, 5B, 5E, 5J, 5P/5L, 8, 5Q-S, and 200-06H (all manufactured by Kyowa Chemical Industry Co., Ltd.).

Component B may be a surface-treated hydrated metal oxide. For example, component B may be a hydrated metal oxide that is surface-treated with a silane coupling agent (component E). By including such component B, the flame-retardant rubber composition can include component E at the same time. Component B surface-treated with a silane coupling agent forms a bond with a polymer such as component A. In this manner, the physical properties of the rubber crosslinked body can be changed.

### 1-3. Component C: Phosphorus Flame-Retardant Plasticizer

Component C is a phosphorus flame-retardant plasticizer. A phosphorus flame-retardant plasticizer is a flame-retardant plasticizer having a phosphorus atom. A phosphorus flame-retardant plasticizer generally has a phosphate ester form.

Examples of component C include an aromatic phosphate ester and an aliphatic phosphate ester. Examples of the aromatic phosphate ester include triphenyl phosphate, cresyl diphenyl phosphate, tricresyl phosphate, cresyl dixylenyl phosphate, trixylenyl phosphate, and condensates thereof (resorcinol bis(diphenyl phosphate), bisphenol A bis(diphenyl phosphate), resorcinol bis(dixylenyl phosphate), and a mixed ester of phosphoric acid and [1,1′-biphenyl]4,4′-diol and phenol). Examples of the aliphatic phosphate ester include trimethyl phosphate, triethyl phosphate, tributyl phosphate, tris(2-butoxyethyl) phosphate, tris(2-chloroethyl) phosphate, tris(1,2-dichloro-2-propyl) phosphate, and tris(2,3-dibromopropyl) phosphate.

Component C preferably contains an aromatic compound having excellent flame retardancy. In one embodiment, component C contains an aromatic phosphate ester.

### 1-4. Component D: Mineral Oil

Component D is mineral oil. Mineral oil generally indicates a petroleum-derived oil solution. Examples of component D include process oil, lubricant oil, paraffin oil, liquid paraffin, petroleum asphalt, and Vaseline. Among these, process oil is preferable. Examples of the process oil include paraffin-based process oil, naphthene-based process oil, and aromatic process oil. Among these, paraffin-based process oil is preferable.

### 1-5. Component E: Silane Coupling Agent

Component E is a silane coupling agent. A silane coupling agent is a compound containing a silicon atom. A silane coupling agent is used for surface modification of a material. A silane coupling agent generally has a hydrolyzable group (e.g., an alkoxy group) and a reactive functional group (a vinyl group, a (meth)acryloyl group, an epoxy group, an amino group, etc.) linked to a silicon atom.

Examples of component E include alkoxysilane having a vinyl group and alkoxysilane having a (meth)acryloyl group. Examples of the alkoxysilane having a vinyl group include vinyltrimethoxysilane, vinyltriethoxysilane, and vinyltris(2-methoxyethoxy)silane. Examples of the alkoxysilane having a (meth)acryloyl group include 3-methacryloxypropyltrimethoxysilane, 3-methacryloxypropylmethyldimethoxysilane, 3-methacryloxypropyltriethoxysilane, 3-methacryloxypropylmethyldiethoxysilane, and 3-acryloxypropyltrimethoxysilane. Component E may be an oligomer of these alkoxysilanes.

Component E binds an inorganic component such as component B and component F to a polymer such as component A. In this manner, the physical properties of the flame-retardant rubber crosslinked body improves. In one embodiment, component E is blended as a surface treatment agent of component B and/or component F in the flame-retardant rubber composition. In one embodiment, component E is blended in the flame-retardant rubber composition separately from component B and/or component F.

### 1-6. Component F: Filler

Component F is a filler. Examples of the filler include carbon black, silica, calcium carbonate, activated calcium carbonate, fine talc, fine silicic acid, zinc oxide, diatomaceous earth, and clay. The surfaces of these fillers may be treated with a silane coupling agent.

Among these, carbon black and/or silica are preferable. Examples of the carbon black include SAF, ISAF, HAF, FEF, and GPF. Further, electrically conductive carbon black (including acetylene black and Ketjen black) is also included in examples of the carbon black. Examples of the silica include fumed silica, precipitated silica, and crystalline silica.

Component F may be a surface-treated filler. For example, component F may be a filler that is surface-treated with a silane coupling agent (component E). By including such component F, the flame-retardant rubber composition can include component E at the same time. The component F that is surface-treated with a silane coupling agent forms a bond with a polymer such as component A. In this manner, the physical properties of the rubber crosslinked body can be changed.

### 1-7. Other Components

The flame-retardant rubber composition may include, other than components A to F, a component usable in the rubber industry. Examples of such a component include a plasticizer and a softener other than component C and component D, an antioxidant and a stabilizer, a processing aid, a crosslinking agent, a co-crosslinking agent, a crosslinking accelerator, a crosslinking acceleration aid, and a crosslinking retarder.

### Plasticizer and Softener

Examples of the plasticizer other than component C and component D include coal tar, fatty oil (including castor oil, linseed oil, rapeseed oil, soy bean oil, and coconut oil), wax (including bees wax and carnauba wax), higher fatty acid, salts thereof, esters thereof, naphthenic acid, pine oil, rosin, derivatives thereof, synthetic polymers (including terpene resin, petroleum resin, and coumarone indene resin), ester-based plasticizers (including dioctyl phthalate and dioctyl adipate), microcrystalline wax, poly-α-olefin (including liquid polybutadiene and modified liquid polybutadiene), hydrocarbon-based synthetic lubricating oil, tall oil, and rubber substitutes (factice).

Examples of higher fatty acid, or higher fatty acid constituting higher fatty acid salts or higher fatty acid esters, include oleic acid, palmitic acid, stearic acid, lauric acid, linoleic acid, abietic acid, erucic acid, myristic acid, arachic acid, lignoceric acid, and ricinoleic acid. The higher fatty acid may be either saturated fatty acid or unsaturated fatty acid. Preferably, the higher fatty acid contains unsaturated fatty acid. The salts of higher fatty acid are usually metal salts. Preferable salts are alkali metal salts or alkali earth metal salts. Examples of the metal salts include lithium salt, potassium salt, sodium salt, barium salt, calcium salt, magnesium salt, aluminum salt, iron salt, and zinc salt. Specific examples of the higher fatty acid and salts thereof include ricinoleic acid, palmitic acid, stearic acid, lauric acid, barium stearate, zinc stearate, and calcium stearate.

### Antioxidant and Stabilizer

Examples of the antioxidant include an amine-based antioxidant, a phenol-based antioxidant, and a sulfur-based antioxidant.

Specific examples of the amine-based antioxidant include aromatic amine (phenylbutylamine, N,N-di-2-naphthyl-p-phenylenediamine, etc.) and amine-ketone. Specific examples of the phenol-based antioxidant include monophenol (including dibutyl hydroxytoluene), bisphenol, and polyphenol (including tetrakis[methylene(3,5-di-t-butyl-4-hydroxy)hydrocinnamate]methane). Specific examples of the sulfur-based antioxidant include thioether (including bis[2-methyl-4-(3-n-alkylthiopropionyloxy)-5-t-butylphenyl]sulfide), dithiocarbamic acid salt (including nickel dibutyl dithiocarbamate), thiourea, 2-mercaptobenzoylimidazole, 2-mercaptobenzoimidazole, zinc salt of 2-mercaptobenzoimidazole, dilauryl thiodipropionate, and distearyl thiodipropionate.

### Processing Aid

Examples of the processing aid include higher fatty acid, salts thereof, and esters thereof as described under the heading of Plasticizer and softener. Further examples of the processing aid include higher fatty acid amides (including oleic acid amide).

### Crosslinking Agent

Examples of the crosslinking agent include organic peroxide. Since organic peroxide does not contain a sulfur-based compound, it does not cause corrosion of metal (especially, silver or copper) in contact with the flame-retardant rubber crosslinked body. Examples of the organic peroxide include t-butyl peroxide, dicumyl peroxide, t-butyl cumyl peroxide, 1,1-di(t-butylperoxy)-3,3,5-trimethylcyclohexane, and 2,5-dimethyl-2,5-di(t-butylperoxy)hexane.

### 1-8. Components Which are Preferably Not Contained

From the viewpoint of reducing the environmental load, the flame-retardant rubber composition preferably does not contain halogen. In the present embodiment, halogen includes fluorine, chlorine, bromine, iodine, and astatine. In the present embodiment, “does not contain halogen” means that a compound containing halogen is not used as a raw material of the flame-retardant rubber composition.

Similarly, from the viewpoint of reducing the environmental load, the flame-retardant rubber composition preferably does not contain antimony trioxide.

### 2. Content of Each Component in Flame-Retardant Rubber Composition

In the flame-retardant rubber composition, the lower limit of the content of component B, when the content of component A is 100 parts by weight, is 80 parts by weight or more, preferably 90 parts by weight or more, and more preferably 100 parts by weight or more. In the flame-retardant rubber composition, the upper limit of the content of component B, when the content of component A is 100 parts by weight, is 200 parts by weight or less, preferably 180 parts by weight or less, more preferably 160 parts by weight or less, and further preferably 150 parts by weight or less.

In the flame-retardant rubber composition, the lower limit of the content of component C, when the content of component A is 100 parts by weight, is 1 part by weight or more and preferably 3 parts by weight or more. In the flame-retardant rubber composition, the upper limit of the content of component C, when the content of component A is 100 parts by weight, is 15 parts by weight or less and preferably 13 parts by weight or less.

In the flame-retardant rubber composition, the lower limit of the content of component D, when the content of component A is 100 parts by weight, is 1 part by weight or more and preferably 3 parts by weight or more. In the flame-retardant rubber composition, the upper limit of the content of component D, when the content of component A is 100 parts by weight, is 30 parts by weight or less, preferably 25 parts by weight or less, more preferably 20 parts by weight or less, and further preferably 15 parts by weight or less.

In the flame-retardant rubber composition, the lower limit of the content of component E, when the content of component A is 100 parts by weight, is 0.01 parts by weight or more, preferably 0.1 parts by weight or more, and more preferably 0.5 parts by weight or more. In the flame-retardant rubber composition, the upper limit of the content of component E, when the content of component A is 100 parts by weight, is 10 parts by weight or less, preferably 7 parts by weight or less, and more preferably 5 parts by weight or less.

In the flame-retardant rubber composition, the lower limit of the content of component F, when the content of component A is 100 parts by weight, is 0.1 parts by weight or more, preferably 1 part by weight or more, and more preferably 5 parts by weight or more. In the flame-retardant rubber composition, the upper limit of the content of component F, when the content of component A is 100 parts by weight, is 40 parts by weight or less and preferably 30 parts by weight or less.

In the flame-retardant rubber composition, the lower limit of the total content of the plasticizer (the total content of component C and component D in one embodiment), when the content of component A is 100 parts by weight, is 2 parts by weight or more and preferably 5 parts by weight or more. In the flame-retardant rubber composition, the upper limit of the total content of the plasticizer (the total content of component C and component D in one embodiment), when the content of component A is 100 parts by weight, is 45 parts by weight or less, preferably 35 parts by weight or less, and more preferably 30 parts by weight or less.

In the flame-retardant rubber composition, the lower limit of the ratio of the content of component B to the total content of the plasticizer (the ratio of the content of component B to the total content of component C and component D in one embodiment) is 2.1 or more, preferably 3.0 or more, and more preferably 5.0 or more. In the flame-retardant rubber composition, the upper limit of the ratio of the content of component B to the total content of the plasticizer (the ratio of the content of component B to the total content of component C and component D in one embodiment) is 100.0 or less, preferably 50.0 or less, more preferably 25.0 or less, and further preferably 15.0 or less.

In the flame-retardant rubber composition, the lower limit of the ratio of component D in the total content of the plasticizer (the ratio of component D in the total content of component C and component D in one embodiment) is 0.0625 or more, preferably 0.1 or more, and more preferably 0.3 or more. In the flame-retardant rubber composition, the upper limit of the ratio of the content of component B to the total content of the plasticizer (the ratio of the content of component B to the total content of component C and component D in one embodiment), when the content of component A is 100 parts by weight, is 0.94 or less, preferably 0.9 or less, and more preferably 0.87 or less.

### 3. Flame-Retardant Rubber Crosslinked Body and Article

A flame-retardant rubber crosslinked body according to the present embodiment is obtained by crosslinking the flame-retardant rubber composition according to the present embodiment. For example, a flame-retardant rubber composition can be produced by kneading the components explained in Section 1. For kneading the components, a kneading machine can be used. Examples of the kneading machine include an open roll, a kneader, a planetary mixer, a Banbury mixer, and an extruder. The kneading temperature may be 25 to 200° C. The kneading time may be 1 minute to 1 hour.

A flame-retardant rubber crosslinked body can be produced by curing the flame-retardant rubber composition. The curing temperature may be 120 to 200° C. The curing time may be 10 seconds to 120 minutes. The cured molded body may be further subjected to secondary curing. The secondary curing temperature may be 120 to 250° C. The secondary curing time may be 30 minutes to 4 hours.

An article according to the present embodiment includes the flame-retardant rubber crosslinked body according to the present embodiment. The article can be prepared by molding and crosslinking the flame-retardant rubber composition. Examples of the molding method include injection molding, transfer molding, infusion molding, compression molding, press processing, and extrusion molding. In one embodiment, the article is a gasket. In the present embodiment, the “gasket” indicates a sealing material to be attached between static members.

### 3-1. Physical Properties of Flame-Retardant Rubber Crosslinked Body

The flame retardancy in the UL94 standard of the flame-retardant rubber crosslinked body is preferably V-0 or higher. That is, the flame retardancy of the flame-retardant rubber crosslinked body is preferably 5VA, 5VB, or V-0. In one embodiment, the flame retardancy of the flame-retardant rubber crosslinked body is V-0.

The lower limit of the Shore A hardness of the flame-retardant rubber crosslinked body is 50 or more and preferably 60 or more. The upper limit of the Shore A hardness of the flame-retardant rubber crosslinked body is 80 or less. When the Shore A hardness is within the above-described range, it is considered that the flame-retardant rubber crosslinked body has a softness suitable for use as a gasket. As described herein, the Shore A hardness is measured by a type A durometer in accordance with JIS K6253. For more specific examples of the measurement method, Examples of the present application can be referred to. Note that the measurement target for the Shore A hardness of the flame-retardant rubber crosslinked body is the flame-retardant rubber crosslinked body not subjected to a heat resistance test or a flammability test.

The upper limit of the compression set of the flame-retardant rubber crosslinked body is 80% or less, preferably 70% or less, more preferably 60% or less, and further preferably 50% or less. As described herein, the flame-retardant rubber crosslinked body after having been subjected to a heat resistance test is used as a sample to measure the compression set. A method for the heat resistance test is the method of revised JIS K6262 (for details, see Examples). Therefore, the value of the compression set is likely to be higher than when measurement was performed in accordance with JIS K6262.

The tensile break point strength of the flame-retardant rubber crosslinked body is 5 MPa or more and preferably 7 MPa or more. The tensile break point elongation of the flame-retardant rubber crosslinked body is 180% or more and preferably 200% or more. When the tensile physical properties is within the above-described range, it is considered that the flame-retardant rubber crosslinked body has rubber physical properties suitable for use as a gasket.

### 4. Conclusion

The present disclosure includes embodiments described below.
(1) A flame-retardant rubber composition including components A to D below, in which contents of the components B to D, when the content of component A is 100 parts by weight, are as follows.
component A: ethylene-propylene-diene rubber;
component B: hydrated metal oxide;
component C: phosphorus flame-retardant plasticizer; and
component D: mineral oil,
component B: 80 to 200 parts by weight;
component C: 1 to 15 parts by weight; and
component D: 1 to 30 parts by weight.
(2) The flame-retardant rubber composition according to (1), in which when the content of component A is 100 parts by weight, a content of the component B is less than 180 parts by weight.
(3) The flame-retardant rubber composition according to (1) or (2), in which the component C contains an aromatic compound.
(4) The flame-retardant rubber composition according to any of (1) to (3), further including component E below:
component E: silane coupling agent.
(5) The flame-retardant rubber composition according to (1), in which the component B contains aluminum hydroxide and/or magnesium hydroxide.
(6) The flame-retardant rubber composition according to any of (1) to (5), further including component F below:
component F: filler.
(7) The flame-retardant rubber composition according to (6), in which the component F contains carbon black and/or silica.
(8) The flame-retardant rubber composition according to any of (1) to (7), in which the flame-retardant rubber composition does not contain halogen and antimony trioxide.
(9) A flame-retardant rubber crosslinked body, obtained by crosslinking the flame-retardant rubber composition according to any of (1) to (8).
(10) The flame-retardant rubber crosslinked body according to (9), satisfying all of physical properties (i) to (iii) below:
(i) a flame retardancy in a UL94 standard is V-0 or higher;
(ii) a Shore A hardness is 50 to 80; and
(iii) a compression set is 80% or less.
(11) An article, including the flame-retardant rubber crosslinked body according to (9) or (10).
(12) The article according to (11), being a gasket.

### EXAMPLES

Hereinafter, the present embodiment will be more specifically described by examples. However, the present embodiment is not limited to these examples.

### Materials Used

### Component A

Ethylene-propylene-diene rubber (EP33, ENEOS Materials Corporation)

### Component B

Hydrated metal oxide 1 (BF013, Nippon Light Metal Co., Ltd., aluminum hydroxide)
Hydrated metal oxide 2 (BF013STM, Nippon Light Metal Co., Ltd., silane coupling agent-treated aluminum hydroxide)
Hydrated metal oxide 3 (BF013STV, Nippon Light Metal Co., Ltd., silane coupling agent-treated aluminum hydroxide)

### Component C

Phosphorus flame-retardant plasticizer 1 (TCP, Daihachi Chemical Industry Co., Ltd., tricresyl phosphate)
Phosphorus flame-retardant plasticizer 2 (Adeka Stab FP-900L, Adeka Corporation, mixed ester of phosphoric acid and [1,1′-biphenyl]4,4′-diol and phenol)

### Component D

Mineral oil (Diana Process Oil PW-380, Idemitsu Kosan Co., Ltd., paraffin-based process oil)

### Component E

Silane coupling agent (KBM-503, Shin-Etsu Chemical Co., Ltd., 3-methacryloxypropyltrimethoxysilane)
   A silane coupling agent is also contained in hydrated metal oxides 2 and 3.

### Component F

Filler 1 (Seast G-SO, Tokai Carbon Co., Ltd., carbon black)
Filler 2 (Nipsil ER, Tosoh Silica Corporation, precipitation method silica)

### Co-Crosslinking Agent

Co-crosslinking agent (Hi-Cross M-P, Seiko Chemical Co., Ltd., trimethylol propane trimethacrylate (TMPTM))

### Crosslinking Agent

Crosslinking agent (Perhexa 25B-40, NOF Corporation, 2,5-dimethyl-2,5-di(t-butylperoxy)hexane)

### Antioxidant

Antioxidant (2,2,4-trimethyl-1,2-dihydroquinoline polymer (TMDQ))

### Processing Aid

Processing aid (stearic acid)

### Examples 1 to 12 and Comparative Examples 1 to 9

According to the following steps, a crosslinked rubber sheet was prepared. The crosslinked rubber sheet was used as a material for preparing a specimen in the later-described test.
1. The components excluding the crosslinking agent described in Table 1 were kneaded by a kneader. The kneading temperature was 50 to 150° C. The kneading time was 10 to 30 minutes.
2. The crosslinking agent was added and kneaded by an open roll. The kneading temperature was 20 to 100° C. The kneading time was 5 to 30 minutes.
3. From the obtained kneaded product, an uncrosslinked rubber sheet was prepared.
4. The uncrosslinked rubber sheet was press-crosslinked at 170° C. for 10 minutes.
5. Furthermore, secondary crosslinking was performed at 180° C. for 1 hour. In this manner, a crosslinked rubber sheet having a thickness of 2 mm was obtained.

### Test Method

### 1. Surface Properties

The surface of the uncrosslinked rubber sheet obtained in step 3 of Examples and Comparative Examples was visually observed. The observation result was evaluated according to the below-described criteria.
+: No defects (blooming, bleeding, blistering, etc.) are observed on the sheet surface.
−: Defects are observed on the sheet surface.

### 2. Shore A Hardness

The Shore A hardness of the crosslinked rubber sheet obtained in step 5 of Examples and Comparative Examples was measured in accordance with JIS K6253. The specific procedure is as follows.
(1) Three crosslinked rubber sheets each having a thickness of 2 mm were stacked to form a measurement sample.
(2) Measurement was performed using a type A durometer at 23° C. and a relative humidity of 50%. The peak value of the durometer was defined as the Shore A hardness.

### 3. Tensile Test

A tensile test was performed in accordance with JIS K6251. Specifically, the tensile break point stress and the tensile break point elongation were measured. The measurement sample used was a dumbbell No. 3 specimen according to JIS K6251, which was punched out from the crosslinked rubber sheet obtained in step 5 of Examples and Comparative Examples.

### 4. Heat Resistance Test

By a method according to revised JIS K6262, the flame-retardant rubber crosslinked body was subjected to a heat resistance test. Thereafter, the compression set was measured. The specific procedure is as follows.
(1) An O ring having a wire diameter of 2.4 mm punched out from the crosslinked rubber sheet obtained in step 5 of Examples and Comparative Examples was used as a measurement sample.
(2) The measurement sample was compressed by 25% and thereafter held in the air at 125° C. for 70 hours.
(3) After the compression was released, the compression set of the flame-retardant rubber crosslinked body was calculated. It is considered that the flame-retardant rubber crosslinked body having a small compression set value exhibits high resilience even after compressed for a long period.

Note that the shape of the measurement sample used in the test method adopted in the present example is different from the shape of the measurement sample defined in JIS K6262. That is, the measurement sample in JIS K6262 has a disc shape. The thickness is 12.5±0.5 mm or 6.3±0.5 mm. On the other hand, the measurement sample adopted in the present example is an O ring having a wire diameter of 2.4 mm. Therefore, the thickness is also 2.4 mm. In general, a rubber product tends to exhibit smaller resilience when released from compression, as the thickness is thinner. Therefore, the value of the compression set measured in the present example tends to be larger than the value measured in accordance with JIS K6262.

### 5. Flammability Test

The flame retardancy based on UL94 (vertical flammability test) was evaluated. The specific procedure is as described below.
(1) A strip sample was vertically attached to a clamp.
(2) Flame retardancy was evaluated in accordance with the 20 mm vertical flammability test (IEC60695-11-10B method, ASTMD3801). Specifically, contact with a 20 mm flame for 10 seconds was performed twice. Thereafter, the flammability behavior of the sample was observed. The evaluation criteria are as follows.
+: A rating of V-0 is satisfied.
−: A rating of V-0 is not satisfied.

### Results

The results of Examples are illustrated in Table 1.

TABLE 1
Table 1

| | | Example 1 | Example 2 | Example 3 | Example 4 | Example 5 | Example 6 |
|---|---|---|---|---|---|---|---|
| Component A | EPDM | 100 | 100 | 100 | 100 | 100 | 100 |
| Component B | Hydrated metal oxide 1 | 150 | 140 | 140 | 140 | 130 | 140 |
| | Hydrated metal oxide 2 | | | | | | |
| | Hydrated metal oxide 3 | | | | | | |
| Component C | Phosphorus flame-retardant plasticizer 1 | 10 | 10 | 5 | 5 | 5 | |
| | Phosphorus flame-retardant plasticizer 2 | | | | | | 5 |
| Component D | Mineral oil | 10 | 10 | 10 | 10 | 10 | 10 |
| Component E | Silane coupling agent | 1 | 1 | 1 | 1 | | 1 |
| Component F | Filler 1 | 20 | 20 | 20 | 20 | 20 | 20 |
| | Filler 2 | | | | | | |
| Antioxidant | | 1 | 1 | 1 | 1 | 1 | 1 |
| Processing aid | | 1 | 1 | 1 | 1 | 1 | 1 |
| Co-crosslinking agent | | 2.3 | 2.3 | 2.3 | 2.3 | 2.3 | 2.3 |
| Crosslinking agent | | 5 | 5 | 5 | 5 | 5 | 5 |
| Component ratio | C+D | 20 | 20 | 15 | 15 | 15 | 15 |
| | B/(C + D) | 7.5 | 7.0 | 9.3 | 9.3 | 8.7 | 9.3 |
| | D/(C + D) | 0.50 | 0.50 | 0.67 | 0.67 | 0.67 | 0.57 |
| Surface properties | | + | | + | + | + | + |
| Shore A hardness | | 74 | 73 | 76 | 76 | 75 | 79 |
| Tensile test | Tensile break point stress (MPa) | 9.7 | 9.0 | 9.3 | 11.7 | 9.7 | 13.0 |
| | Tensile break point elongation (%) | 230 | 270 | 230 | 220 | 230 | 130 |
| Heat resistance test | Compression set | 22 | 19 | 18 | 17 | 14 | 15 |
| Flammability test | V-0 | + | + | + | + | + | + |
| | | Example 7 | Example 8 | Example 9 | Example 10 | Example 11 | Example 12 |
| Component A | EPDM | 100 | 100 | 100 | 100 | 100 | 100 |
| Component B | Hydrated metal oxide 1 | 140 | 120 | 100 | 100 | 80 | 200 |
| | Hydrated metal oxide 2 | | | | | | |
| | Hydrated metal oxide 3 | | | | | | |
| Component C | Phosphorus flame-retardant plasticizer 1 | | 6 | 5 | 5 | 5 | 5 |
| | Phosphorus flame-retardant plasticizer 2 | 10 | | | | | |
| Component D | Mineral oil | 10 | 10 | 5 | 5 | 5 | 30 |
| Component E | Silane coupling agent | 1 | 1 | 1 | | 1 | 1 |
| Component F | Filler 1 | 20 | 20 | 20 | | 20 | 20 |
| | Filler 2 | | | | 30 | | |
| Antioxidant | | 1 | 1 | 1 | 1 | 1 | 1 |
| Processing aid | | 1 | 1 | 1 | | 1 | 1 |
| Co-crosslinking agent | | 2.3 | 2.3 | 2.3 | 2.3 | 2.3 | 2.3 |
| Crosslinking agent | | 5 | 5 | 5 | 5.6 | 5 | 5 |
| Component ratio | C+D | 20 | 15 | 10 | 10 | 10 | 35 |
| | B/(C + D) | 7.0 | 8.0 | 10.0 | 10.0 | 8.0 | 5.7 |
| | D/(C + D) | 0.50 | 0.67 | 0.50 | 0.50 | 0.50 | 0.85 |
| Surface properties | | + | + | + | | + | + |
| Shore A hardness | | 75 | 73 | 74 | 77 | 71 | 74 |
| Tensile test | Tensile break point stress (MPa) | 11.8 | 8.4 | 8.3 | 9.1 | 8.5 | 11.6 |
| | Tensile break point elongation (%) | 180 | 280 | 260 | 330 | 300 | 200 |
| Heat resistance test | Compression set | 17 | 15 | 17 | 25 | 17 | 17 |
| Flammability test | V-0 | + | + | + | + | + | + |

Unit of blended amount of each component: parts by weight

The rubber crosslinked bodies of Examples included all of components A to D. Further, the content of each component satisfied predetermined conditions. As understood from Table 1, these rubber crosslinked bodies were found to be excellent in surface properties, flexibility (Shore A hardness and tensile break point elongation), and flame retardancy. Further, all of these physical properties were achieved at high levels. In addition, these rubber crosslinked bodies were also excellent in tensile strength and heat resistance.

In comparison between Example 1 and Example 12, the blended amount of component B is preferably not excessively large (for example, preferably 180 parts by weight or less with respect to 100 parts by weight of component A), for a purpose of improving the tensile break point elongation of the rubber crosslinked body. In comparison between Examples 2 and 3 and Examples 6 and 7, an uncondensed phosphate ester is preferably used (for example, tricresyl phosphate is preferably used) as component C, for a purpose of improving the tensile break point elongation of the rubber crosslinked body.

The results of Comparative Examples are illustrated in Table 2.

TABLE 2
Table 2

| | | Comparative | Comparative | Comparative | Comparative | Comparative |
|---|---|---|---|---|---|---|
| | | Example 1 | Example 2 | Example 3 | Example 4 | Example 5 |
| Component A | EPDM | 100 | 100 | 100 | 100 | 100 |
| Component B | Hydrated metal oxide 1 | | 130 | | 150 | 150 |
| | Hydrated metal oxide 2 | | | | | |
| | Hydrated metal oxide 3 | | | 150 | | |
| Component C | Phosphorus flame-retardant plasticizer 1 | | | 10 | | |
| | Phosphorus flame-retardant plasticizer 2 | | | | | |
| Component D | Mineral oil | 40 | 40 | | 5 | 5 |
| Component E | Silane coupling agent | | | | 1 | 1 |
| Component F | Filler 1 | 90 | 90 | 30 | | 10 |
| | Filler 2 | | | | 30 | |
| Antioxidant | | 1 | 1 | 1 | 1 | 1 |
| Processing ald | | 1 | 1 | 1 | 1 | 1 |
| Co-crosslinking agent | | 2.3 | 2.3 | 2.3 | 2.3 | 2.3 |
| Crosslinking agent | | 5.6 | 5.6 | 5 | 5 | 5 |
| Component ratio | C+D | 40 | 40 | 10 | 5 | 5 |
| | B/(C + D) | 0 | 3.3 | 15.0 | 30.0 | 30.0 |
| | D/(C + D) | 1.00 | 1.00 | 1.006 | 1.00 | 1.00 |
| Surface properties | | + | + | + | + | + |
| Shore A hardness | | 60 | 73 | 81 | 87 | 82 |
| Tensile test | Tensile break point stress (MPa) | 13.3 | 8.6 | 10.5 | 9.2 | 11.7 |
| | Tensile break point elongation (%) | 290 | 260 | 260 | 290 | 170 |
| Heat resistance test | Compression set | 23 | 33 | 15 | Not | Not |
| | | | | | measured | measured |
| Flammability test | V-0 | − | − | Not | Not | Not |
| | | | | measured | measured | measured |
| | | | Comparative | Comparative | Comparative | Comparative |
| | | | Example 6 | Example 7 | Example 8 | Example 9 |
| Component A | EPDM | | 100 | 100 | 100 | 100 |
| Component B | Hydrated metal oxide 1 | | 150 | 220 | 200 | 60 |
| | Hydrated metal oxide 2 | | | | | |
| | Hydrated metal oxide 3 | | | | | |
| Component C | Phosphorus flame-retardant plasticizer 1 | | 20 | 5 | 5 | 5 |
| | Phosphorus flame-retardant plasticizer 2 | | | | | |
| Component D | Mineral oil | | | 20 | 40 | 5 |
| Component E | Silane coupling agent | | | 1 | 1 | 1 |
| Component F | Filler 1 | | 30 | 20 | 20 | 20 |
| | Filler 2 | | | | | |
| Antioxidant | | | 1 | 1 | 1 | 1 |
| Processing ald | | | 1 | 1 | 1 | 1 |
| Co-crosslinking agent | | | 2.3 | 2.3 | 2.3 | 2.3 |
| Crosslinking agent | | | 5 | 5 | 5 | 5 |
| Component ratio | C+D | | 20 | 25 | 45 | 10 |
| | B/(C + D) | | 7.5 | 8.8 | 4.4 | 6.0 |
| | D/(C + D) | | 0 | 0.80 | 0.89 | 0.50 |
| Surface properties | | | − | + | − | + |
| Shore A hardness | | | Not | 81 | 70 | 67 |
| | | | measured | | | |
| Tensile test | Tensile break point stress (MPa) | | Not | 11.0 | 10.1 | 9.9 |
| | | | measured | | | |
| | Tensile break point elongation (%) | | Not | 170 | 210 | 270 |
| | | | measured | | | |
| Heat resistance test | Compression set | | Not | Not | Not | Not |
| | | | measured | measured | measured | measured |
| Flammability test | V-0 | | Not | Not | Not | − |
| | | | measured | measured | measured | |

Unit of blended amount of each component: parts by weight

In the rubber crosslinked bodies according to Comparative Examples, a part of components A to D was not contained, or the content of any of the components did not satisfy predetermined conditions. As a result, any of the surface properties, flexibility, and flame retardancy of these rubber crosslinked bodies remained at insufficient levels.

Specifically, when no component D was blended, and only component C was blended in a large amount, the rubber crosslinked body was excessively hard (Comparative Example 3). Alternatively, blistering or the like occurred on the surface of the rubber crosslinked body (Comparative Example 6). Conversely, when no component C was blended, and component D was blended in a large amount, the flame retardancy of the rubber crosslinked body was insufficient (Comparative Example 1). This result was not changed even when component B was blended as a flame retardant (Comparative Example 2). When the blended amount of component D was reduced in order to improve flame retardancy, the rubber crosslinked body was excessively hard (Comparative Examples 4 and 5). As understood from these results, both of component C and component D need to be blended in order for the rubber crosslinked body to satisfy all of surface properties, flexibility, and flame retardancy at high levels.

Furthermore, when the blended amount of component B was excessively large, the rubber crosslinked body tended to be excessively hard (Comparative Example 7). On the other hand, when the blended amount of component B was excessively small, the flame retardancy of the rubber crosslinked body tended to be insufficient (Comparative Example 9). When component D was excessively blended, and the blended amount of component B was large, the rubber crosslinked body was inferior in surface properties (Comparative Example 8).

The flame-retardant rubber composition and the flame-retardant rubber crosslinked body according to the present embodiment can be used for preparation of rubber parts such as a gasket.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A flame-retardant rubber composition, comprising:
components A to D below,
component A: ethylene-propylene-diene rubber;
component B: hydrated metal oxide;
component C: phosphorus flame-retardant plasticizer; and
component D: mineral oil,
wherein when a content of the component A is 100 parts by weight,
a content of the component B is 80 to 200 parts by weight,
a content of the component C is 1 to 15 parts by weight, and
a content of the component D is 1 to 30 parts by weight.

2. The flame-retardant rubber composition according to claim 1,
wherein when the content of the component A is 100 parts by weight, the content of the component B is less than 180 parts by weight.

3. The flame-retardant rubber composition according to claim 1,
wherein the component C contains an aromatic compound.

4. The flame-retardant rubber composition according to claim 1, further comprising:
component E below:
component E: silane coupling agent.

5. The flame-retardant rubber composition according to claim 1,
wherein the component B contains aluminum hydroxide and/or magnesium hydroxide.

6. The flame-retardant rubber composition according to claim 1, further comprising:
component F below:
component F: filler.

7. The flame-retardant rubber composition according to claim 6,
wherein the component F contains carbon black and/or silica.

8. The flame-retardant rubber composition according to claim 1,
wherein the flame-retardant rubber composition does not contain halogen and antimony trioxide.

9. A flame-retardant rubber crosslinked body, obtained by crosslinking the flame-retardant rubber composition according to claim 1.

10. The flame-retardant rubber crosslinked body according to claim 9,
satisfying all of physical properties (i) to (iii) below:
(i) a flame retardancy in a UL94 standard is V-0 or higher;
(ii) a shore A hardness is 50 to 80; and
(iii) a compression set is 80% or less.

11. An article, comprising:
the flame-retardant rubber crosslinked body according to claim 9.

12. The article according to claim 11, being a gasket.
